(19) United States
(12) Patent Application Publication
(10) Pub. No.: US 2023/0309511 A1
(43) Pub. Date: Oct. 5, 2023

(54) AUTONOMOUS LIVESTOCK MOVEMENT

(71) Applicants: Elmoustapha OULD-AHMED-VALL, Chandler, AZ (US); Rama Kishan MALLADI, Bangalore (IN); Robert VAUGHN, Portland, OR (US); Matthias HAHN, Feldkirchen (DE); Sunny GOGAR, Beaverton, OR (US)

(72) Inventors: Elmoustapha OULD-AHMED-VALL, Chandler, AZ (US); Rama Kishan MALLADI, Bangalore (IN); Robert VAUGHN, Portland, OR (US); Matthias HAHN, Feldkirchen (DE); Sunny GOGAR, Beaverton, OR (US)

(21) Appl. No.: 17/712,115

(22) Filed: Apr. 2, 2022

(51) Int. Cl. A01K 11/00; G06Q 50/02; A01K 15/02

(52) U.S. Cl. CPC A01K 11/008; G06Q 50/02; A01K 15/029; A01K 15/028

(57) ABSTRACT

Techniques for autonomous animal movement are described. In some examples, animal tracking and movement software is used to provide input from a physical stimulus to direct movement of the animal coupled to an apparatus along a multi-turn route using physical output of the physical stimulus device based at least in part on a location of the animal with respect to a destination grazing area.

### BACKGROUND

Free range and herd animals, whether livestock or wild, due to a general collapse of open lands and impact of global climate change have created situations where animals are at risk for finding water and feed grasses. The waste product of livestock (such as cows, sheep, camels, etc.) is problematic in that it reduces the effective grazing acreage through grass spoilage, harms the environment (for example, adds extra ammonia, phosphorus, potassium, etc. which can cause surface water pollution/leaching and/or, contaminated watersheds/aquifers, etc.) and is difficult to gather/retrieve. The problem is global in scale.

### BRIEF DESCRIPTION OF DRAWINGS

Various examples in accordance with the present disclosure will be described with reference to the drawings, in which:

FIG. 1 illustrates examples of one or more systems to dictate animal movement.

FIG. 2 illustrates examples of one or more systems to dictate animal movement.

FIG. 3 illustrates examples of an animal behavioral device.

FIG. 4 illustrates examples of an environment monitoring device.

FIG. 5 illustrates examples of aspects an animal tracking and/or movement service and/or animal tracking and/or movement software.

FIG. 6 illustrates examples of a route generated by the route determiner.

FIG. 7 illustrates examples of a method for automated livestock migration.

FIG. 8 illustrates an exemplary system.

FIG. 9 illustrates a block diagram of an example processor 900 that may have more than one core and an integrated memory controller.

### DETAILED DESCRIPTION

The present disclosure relates to methods, apparatus, systems, and non-transitory computer-readable storage media for autonomous livestock movement.

As noted above, waste product from livestock, and wild grazing animals to a lesser extent, can prove problematic when deposited in a manner or location conducive to increased pollutant concentration. So, a rancher, for example, may have employees use a skid loader or shovels to pick up solid waste. Liquid waste (fecal dilution in wet environments or urine) is simply left to be absorbed into the surface soil, subsoil and eventually to the water table.

Herd animals may find the location of water (such as watering holes) from memory or smell (secondary inference via adjacent molecular identification). In effect animals will walk around until they find water. The same goes for grass (food) identification. Watering locations may become unavailable for various reasons which may require animal managers (for example, ranchers, herders, etc.) to spend considerable time moving animals from one location to another as well as additional time in “retraining” animals to go to another location. Additionally, the route to water and/or food may become obstructed. How does one most effectively train a camel or cow to follow a different path?

Detailed here in examples by which animals, again whether wild or domesticated and of a grazing nature, will be able to (1) share knowledge of resources, such as water, to other animals and (2) deposit their waste in more effective locations or areas by being autonomously migrated. In some examples, a proprioceptive device is mounted upon two or more points upon an animal. Those devices will have vibrating motors and/or other stimulus devices (e.g., electric, auditory, obstruction by drone, smell, etc.) to provide a stimulus to the animal. Additional sensors embedded in those devices can be used to detect animal movement, location, gas/chemical sensing, sound, (etc.). A plurality of sensor data will be analyzed to make observations about the environment. Those devices will provide sensory input (such as feedback) via electric off-balance micro-motors (vibrating motors) and/or other stimulus devices. That sensory input will effectively train the animal in a reward/response manner. That subsequent control will allow for the animals to be steered or directed along a path of the operators choosing.

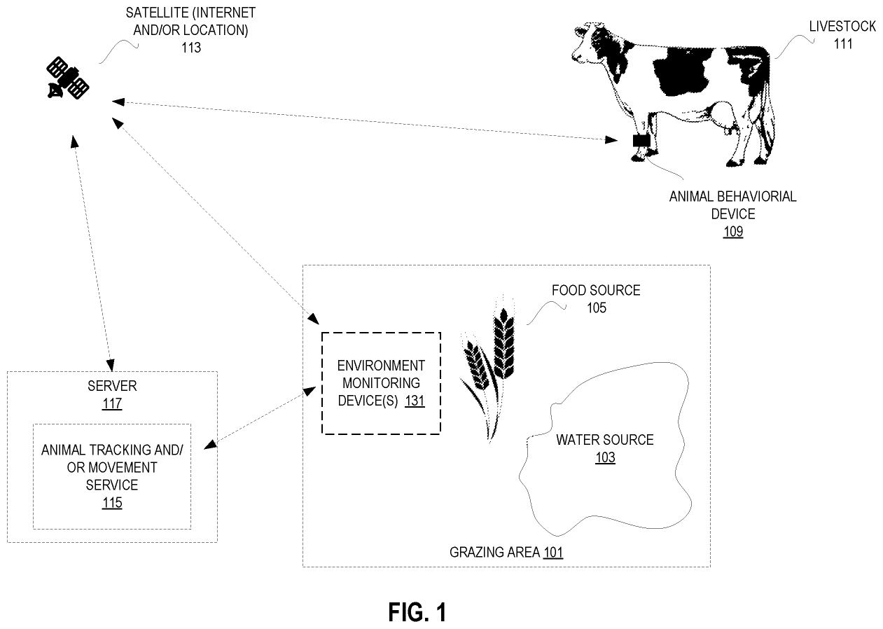

FIG. 1 illustrates examples of one or more systems to dictate animal movement. Livestock animals 111 are to be location trained to identify grazing areas 101(A)-(B). One or more livestock animals 111 of a group (or herd) have an animal behavioral device 109 attached (such as by a collar, bracelet, etc.) or implanted. Examples of animal behavioral device(s) are detailed later. The animal behavioral device 109 communicates with one or more of a satellite 113, server 117, and/or other devices (such as a handheld device, non-satellite aerial device, etc.). In some examples, the animal behavioral device 109 is used to provide internet, for example from satellite 113, to nearby devices.

In some examples, the livestock animals 111 are trained using aspects of reinforcement-based techniques. For example, positive stimuli to reinforce the desired behavior of going to a particular grazing location. In some examples, stimuli training comprising providing a particular stimulus per feeding location a distinct vibration pattern will be issued at a given amplitude is performed. In some examples, stimuli training uses audio signals to train (e.g., as a reward) and/or negative stimuli such as electrical stimuli.

The training, in some examples, uses classical or operant conditioning. Classical conditioning is a form of associative learning where a conditioned stimulus is paired with an unconditioned stimulus. At least some research has shown that classical conditioning may not be the optimal approach to teach cattle perform act in a specific location. Operant conditioning is a process of behavioral modification in which the likelihood of a specific behavior is either increased or decreased using reinforcement or punishment. Operant conditioning can be used to train cattle to approach or avoid a location. However, sensory, cognitive, and locomotor abilities vary between livestock species different training techniques may need to be implemented.

Each grazing area 101 includes a food source 105 and/or a water source 103 that is suitable for the livestock animals 111. In some examples, a grazing area 101 additionally includes one or more environment monitoring device(s) 131. These one or more devices 131 may monitor precipitation, an amount of surface water available, soil conditions, etc. The one or more devices 131 may include a capability of providing images (still and/or video) and/or audio. The one or more devices 131 include communication capabilities in some examples. Exemplary, but non-limiting communication capabilities include satellite communications to communicate with satellite 113, wired communications (such as powerline or modem), and/or wireless communications (such as Wi-Fi, Bluetooth, to a non-satellite aerial platform, etc.). In some examples, remote sensing is used to monitor grazing area conditions. For example, satellite and/or unmanned aerial vehicles (UAV) may be used to provide images to estimate spatial and temporal changes in grazing areas.

In some examples, environment monitoring device(s) 131 communicate with a server 117 or another device which includes an animal tracking and/or movement means such as an animal tracking and/or movement service 115. The animal tracking and/or movement service 115 includes software to do one or more of: determining routes for the livestock animals, tracking livestock animal movement, determining when livestock should move, and/or communicating with animal behavioral device(s) 109 and/or environment monitoring device(s) 131. Note that the server 117 may be a physical server or a virtual server that is run on premises or on a cloud provider's network.

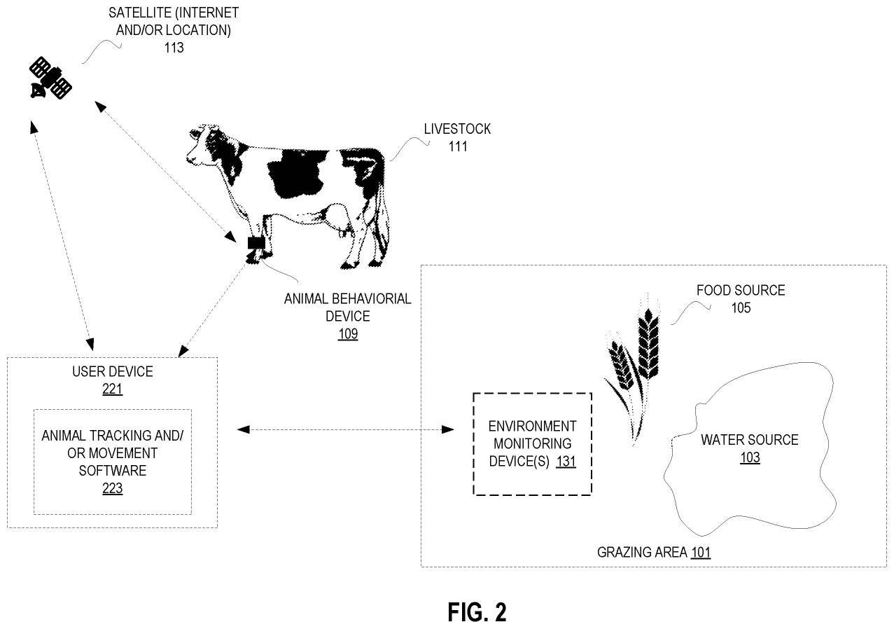

FIG. 2 illustrates examples of one or more systems to dictate animal movement. This figure is similar to FIG. 1, but a user device 221 is used instead of, or in conjunction with. a server 117. In some examples, environment monitoring device(s) 131 communicate with the user device 221 or another device which includes an animal tracking and/or movement means such as an animal tracking and/or movement software 123. The animal tracking and/or movement software 123 includes software to do one or more of: determining routes for the livestock animals, tracking livestock animal movement, determining when livestock should move, and/or communicating with animal behavioral device(s) 109 and/or environment monitoring device(s) 131. The user device 221 may also be used to communicate with a satellite 113 and/or animal behavioral device(s) 109.

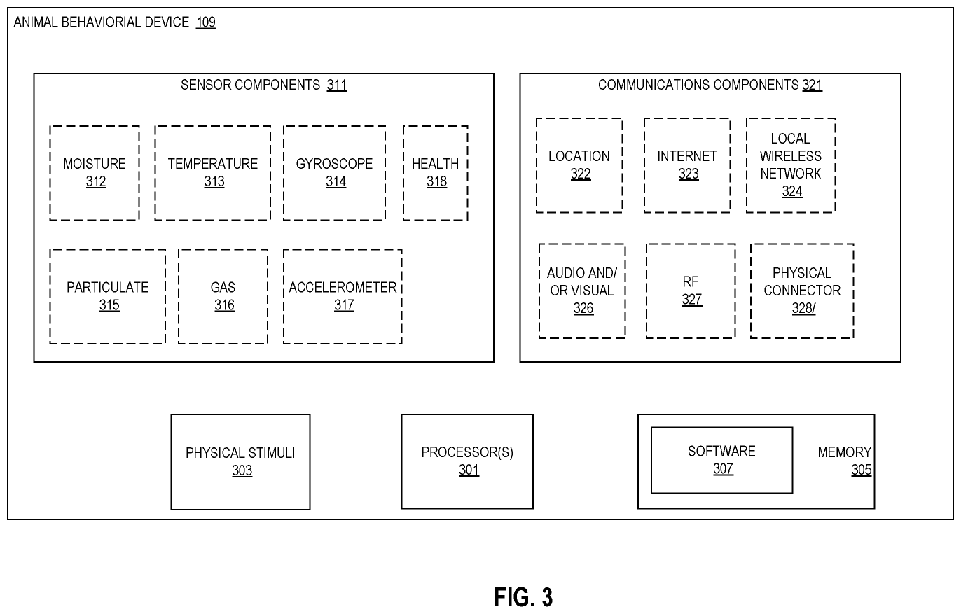

FIG. 3 illustrates examples of an animal behavioral device 109. The animal behavioral device 109 has one or more sensor components 311. For example, an animal behavioral device 109 may include one or more of a moisture sensor 312 (to detect rain, surface water, etc.), a ambient temperature sensor 313, a gyroscope 314, one or more health sensors 318 (blood pressure, body temperature sensor, etc.), one or more particulate sensors 315 (to detect pollution), one or more gas sensors 316, and/or an accelerometer 317.

The animal behavioral device 109 has one or more communication components 321. For example, an animal behavioral device 109 may include one or more of a location component 322 (to give the animal's location), an internet connection component 323 (such as a connection to a satellite, UAV, etc.), a local wireless network component 324, one or more health audio and/or visual component 326, one or more radio frequency components 327, and/or one or more physical connectors 328 (e.g., RS232, USB, etc.).

The animal behavioral device 109 includes one or more physical stimuli 303 that is under control of software 307 (stored in memory 305 and executed by one or more processors 301). The physical stimuli 303 may include one or more of electrical stimuli, vibration stimuli (such as micromotors), etc. Note that that audio and/or visual components 326 may also be used as stimuli.

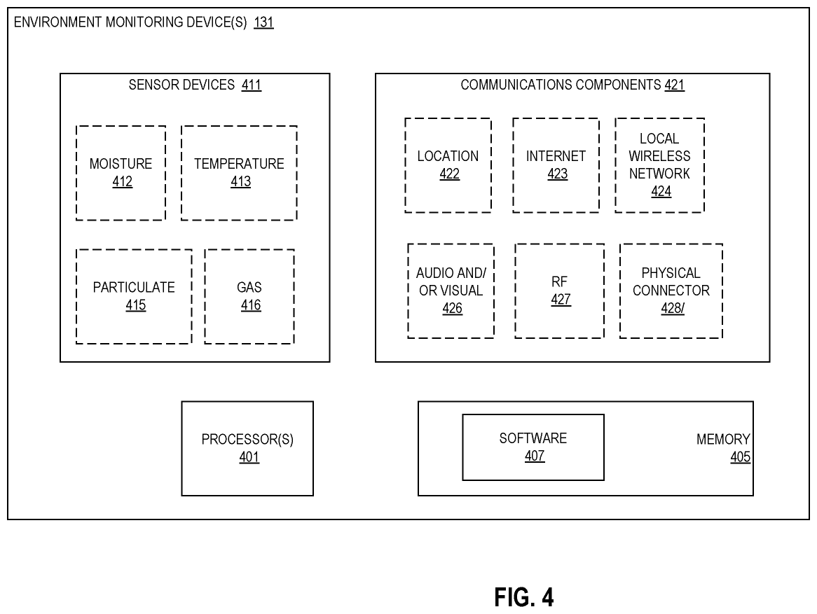

FIG. 4 illustrates examples of an environment monitoring device 131. The environment monitoring device 131 has one or more sensor components 411. For example, an environment monitoring device 131 may include one or more of a moisture sensor 412 (to detect rain, surface water, etc.), a ambient temperature sensor 413, a gyroscope 414, one or more particulate sensors 415 (to detect pollution), and/or one or more gas sensors 416.

The environment monitoring device 131 has one or more communication components 421. For example, an environment monitoring device 131 may include one or more of a location component 422 (to give the device's location), an internet connection component 423 (such as a connection to a satellite, UAV, etc.), a local wireless network component 424, one or more health audio and/or visual component 426, one or more radio frequency components 427, and/or one or more physical connectors 428 (e.g., RS232, USB, etc.).

The environment monitoring device 131 includes software 407 stored in memory 405 and executed by one or more processors 401. The software 407 interacts with the sensor devices 411 and communications components 421 to collect and share environmental data.

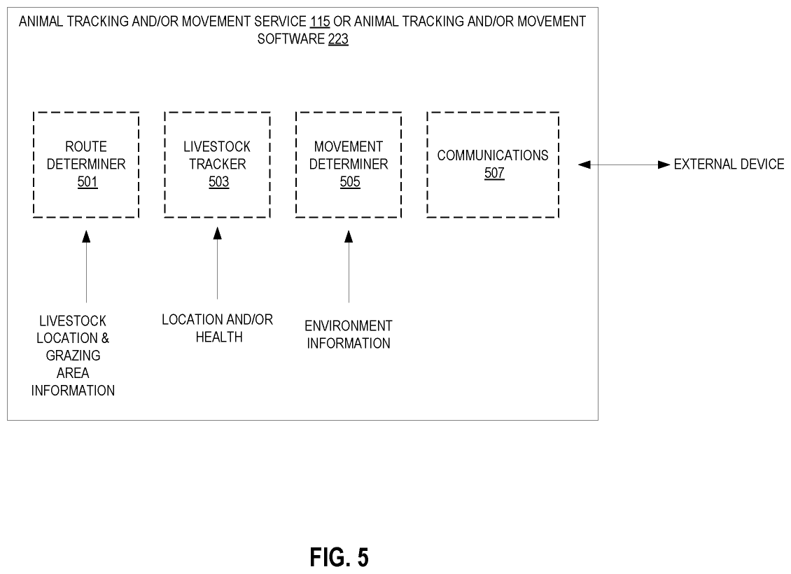

FIG. 5 illustrates examples of aspects an animal tracking and/or movement service 115 and/or animal tracking and/or movement software 223. As shown, the animal tracking and/or movement service 115 and/or animal tracking and/or movement software 223 may have several different capabilities.

A route determiner 501 uses at least location information of livestock and grazing area information to determine a route for livestock to take. As noted above, an animal is to be route trained or “steered” once on a route. Typically, a route comprises one or more waypoints for the livestock to be redirected (“steered”) based on some sort of stimuli.

In some examples, a route is programmed to use a particular frequency with varied amplitudes. In some examples, while an animal is in route to feeding location (e.g., using vb₁) the amplitude used to guide the animal (e.g., a_{md}) is modified by distance. Distance could be measured using signal triangulation, GPS, etc. Hence, amplitude will be relative to distance. Below is an exemplary approach to calculating an amplitude at a given point in time or distance.

```
#ma = max amplitude
#la = min amplitude
#a = amplitude
#us = unit spread
#d = distance
#sd = start distance
#td = radius of target in meters (target is relative... could be a gate,
could be a field)
ma = 160 (value is relative, in humans 151 >180 Hz, amplitude used
to vary intensity))
la = 40
us = la/d
td = 10
while True:
  a = ((sd − d)* us))
  set_a( ) #call to undefined function to set amplitude
  if d < td:
```

To aid in routing an animal along fences the following logic may be applied. The distance (d) may be manipulated with respect to encouraging the animal to follow a complex route. In such cases (d) may be a moving target that is geospatially placed per route requirements.

In some examples, a route does not rely in vibrations, but relies on other stimuli (such as smell, sound, light, electrical, etc.) at given waypoints.

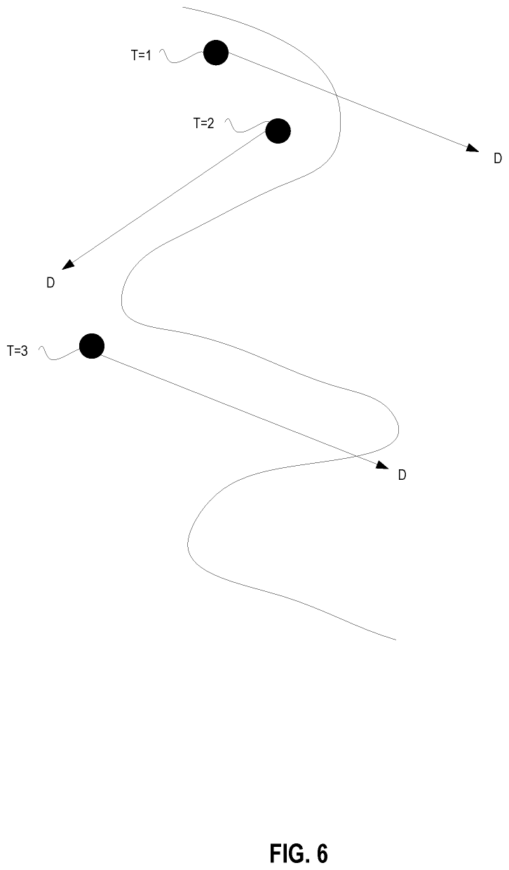

FIG. 6 illustrates examples of a route generated by the route determiner 501. In particular, a route “r” for an animal to follow is shown. The route is not a simple point A to B, but rather the route has complex turns. To facilitate routing of the animal the route may place, in part, “d” at different spatial orientations. Additionally, to help with guiding the animal, in some examples, two or more animal behavioral devices, one attached to each front angle, will vibrate at different amplitudes to help direct the animal.

Two devices may not be sufficient to tell the animal whether to go backwards or forwards. Of course, the route could be coded to provide for a curve to make the animal turn around. Additional devices could be added to the animal to refine control.

In some examples, a livestock tracker 503 tracks a location of livestock and/or the health of the livestock. The location and/or health information may be provided by an animal behavioral device. In some examples, the location of livestock may be provided by using visual and/or thermal images taken from UAVs, satellites, etc.

In some examples, a movement determiner 505 determines when and/or if livestock should be moved. The determination is made based on at least environment information of grazing areas (such as an area currently being used and other known grazing areas). The environmental information may also include forecast information (such as temperature, precipitation, etc.). Additionally, if the health of livestock appears to be changing that information may be used to move the livestock to a different location.

In some examples, communications software 507 communicates with external devices such as livestock (provides a route, receives information from devices on the livestock, etc.), a satellite, a handheld device, etc.

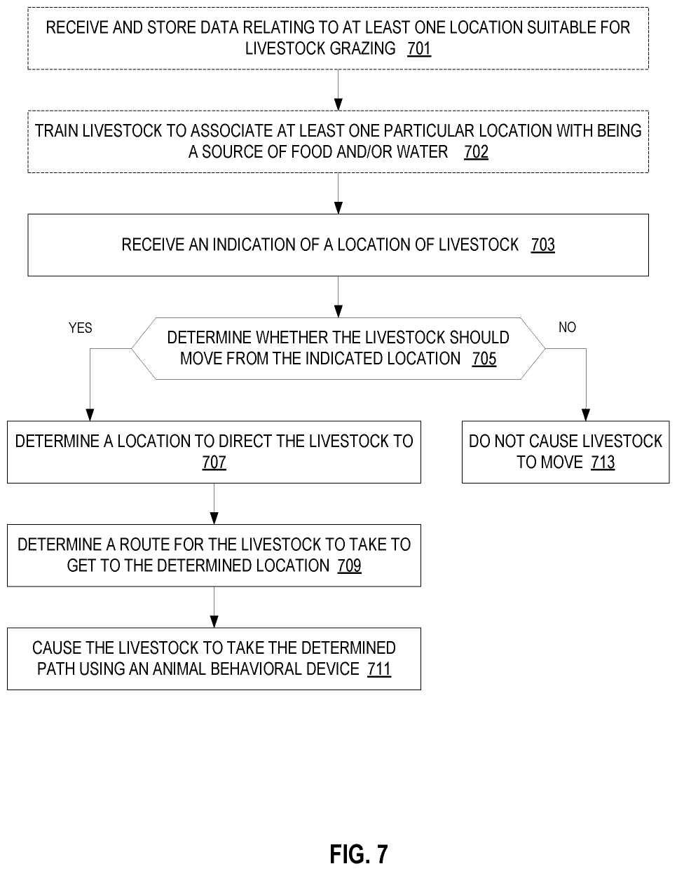

FIG. 7 illustrates examples of a method for automated livestock migration. Some or all of the operations (or other processes described herein, or variations, and/or combinations thereof) are performed under the control of one or more computer systems configured with executable instructions, and are implemented as code (e.g., executable instructions, one or more computer programs, or one or more applications) executing collectively on one or more processors. The code is stored on a computer-readable storage medium, for example, in the form of a computer program comprising instructions executable by one or more processors. The computer-readable storage medium is non-transitory. In some embodiments, one or more (or all) of the operations are performed by one or more of the animal tracking and/or movement service 115 and/or animal tracking and/or movement software 223 of the other figures.

In some examples, at 701 data relating to at least one location suitable for livestock grazing is received. For example, this data may include location information (such as a GPS or other position), types of vegetation, available water, etc.

In some examples, livestock is trained to associate at least one particular location with being a source of food and/or water at 702. This may be done using smell, sound, light, vibration, electrical, or another stimulus. In some examples, this training is performed by the animal tracking and/or movement service 115 and/or animal tracking and/or movement software 223 causing an animal behavioral device to provide the stimulus.

An indication of a location of livestock is received at 703. For example, a GPS location is provided. The location may also be provided by a user.

A determination of whether the livestock should move from the indicated location is made at 705. This determination may take into account current conditions at a grazing area, forecasted conditions of a grazing area, distances between grazing areas, etc.

When it is determined that livestock should move, a location to direct the livestock to is determined at 707. This determination may take into account distance, environmental factors, and/or other factors (such as a need for internet via an animal behavioral device at a particular location).

A route for the livestock to take to get to the determined location is at planned at 709. The route is sent to one or more animal behavioral devices of the livestock.

The livestock are caused to take the determined route using stimulus of provided by an animal behavioral device at 711.

When it is determined that livestock should move, no route is sent to one or more animal behavioral devices of the livestock and the livestock are not disturbed at 713.

Detailed below are describes of exemplary computer architectures which may be used to implement a server 117, user device 521, or aspects of an animal behavioral device 109. Other system designs and configurations known in the arts for laptop, desktop, and handheld personal computers (PC)s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

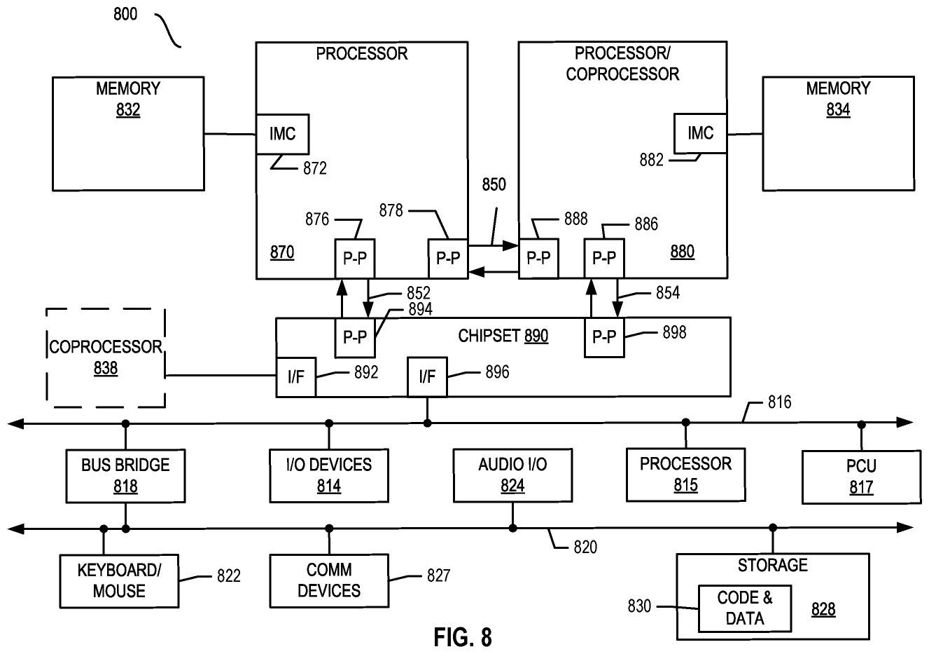

FIG. 8 illustrates an exemplary system. Multiprocessor system 800 is a point-to-point interconnect system and includes a plurality of processors including a first processor 870 and a second processor 880 coupled via a point-to-point interconnect 850. In some examples, the first processor 870 and the second processor 880 are homogeneous. In some examples, first processor 870 and the second processor 880 are heterogenous.

Processors 870 and 880 are shown including integrated memory controller (IMC) units circuitry 872 and 882, respectively. Processor 870 also includes as part of its interconnect controller units point-to-point (P-P) interfaces 876 and 878; similarly, second processor 880 includes P-P interfaces 886 and 888. Processors 870, 880 may exchange information via the point-to-point (P-P) interconnect 850 using P-P interface circuits 878, 888. IMCs 872 and 882 couple the processors 870, 880 to respective memories, namely a memory 832 and a memory 834, which may be portions of main memory locally attached to the respective processors.

Processors 870, 880 may each exchange information with a chipset 890 via individual P-P interconnects 852, 854 using point to point interface circuits 876, 894, 886, 898. Chipset 890 may optionally exchange information with a coprocessor 838 via a high-performance interface 892. In some examples, the coprocessor 838 is a special-purpose processor, such as, for example, a high-throughput processor, a network or communication processor, compression engine, graphics processor, general purpose graphics processing unit (GPGPU), embedded processor, or the like.

A shared cache (not shown) may be included in either processor 870, 880 or outside of both processors, yet connected with the processors via P-P interconnect, such that either or both processors' local cache information may be stored in the shared cache if a processor is placed into a low power mode.

Chipset 890 may be coupled to a first interconnect 816 via an interface 896. In some examples, first interconnect 816 may be a Peripheral Component Interconnect (PCI) interconnect, or an interconnect such as a PCI Express interconnect or another I/O interconnect. In some examples, one of the interconnects couples to a power control unit (PCU) 817, which may include circuitry, software, and/or firmware to perform power management operations with regard to the processors 870, 880 and/or co-processor 838. PCU 817 provides control information to a voltage regulator (not shown) to cause the voltage regulator to generate the appropriate regulated voltage. PCU 817 also provides control information to control the operating voltage generated. In various examples, PCU 817 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 817 is illustrated as being present as logic separate from the processor 870 and/or processor 880. In other cases, PCU 817 may execute on a given one or more of cores (not shown) of processor 870 or 880. In some cases, PCU 817 may be implemented as a microcontroller (dedicated or general-purpose) or other control logic configured to execute its own dedicated power management code, sometimes referred to as P-code. In yet other examples, power management operations to be performed by PCU 817 may be implemented externally to a processor, such as by way of a separate power management integrated circuit (PMIC) or another component external to the processor. In yet other examples, power management operations to be performed by PCU 817 may be implemented within BIOS or other system software.

Various I/O devices 814 may be coupled to first interconnect 816, along with a bus bridge 818 which couples first interconnect 816 to a second interconnect 820. In some examples, one or more additional processor(s) 815, such as coprocessors, high-throughput many integrated core (MIC) processors, GPGPUs, accelerators (such as graphics accelerators or digital signal processing (DSP) units), field programmable gate arrays (FPGAs), or any other processor, are coupled to first interconnect 816. In some examples, second interconnect 820 may be a low pin count (LPC) interconnect. Various devices may be coupled to second interconnect 820 including, for example, a keyboard and/or mouse 822, communication devices 827 and a storage circuitry 828. Storage circuitry 828 may be a disk drive or other mass storage device which may include instructions/code and data 830, in some examples. Further, an audio I/O 824 may be coupled to second interconnect 820. Note that other architectures than the point-to-point architecture described above are possible. For example, instead of the point-to-point architecture, a system such as multiprocessor system 800 may implement a multi-drop interconnect or other such architecture.

### Exemplary Core Architectures, Processors, and Computer Architectures

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may include on the same die as the described CPU (sometimes referred to as the application core(s) or application processor(s)), the above described coprocessor, and additional functionality. Exemplary core architectures are described next, followed by descriptions of exemplary processors and computer architectures.

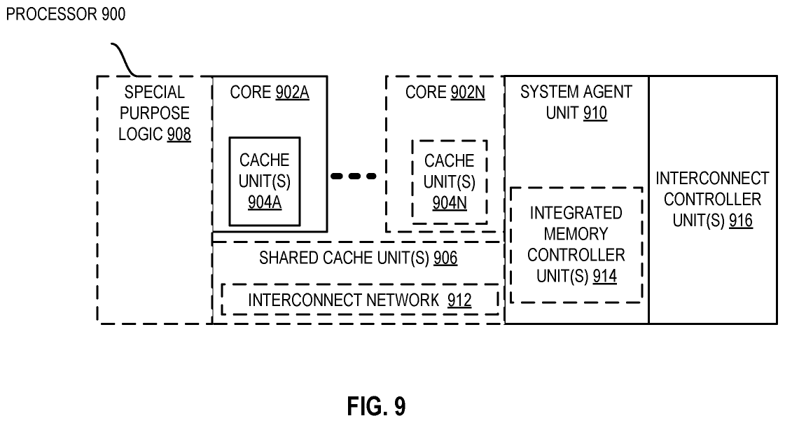

FIG. 9 illustrates a block diagram of an example processor 900 that may have more than one core and an integrated memory controller. The solid lined boxes illustrate a processor 900 with a single core 902A, a system agent 910, a set of one or more interconnect controller unit(s) circuitry 916, while the optional addition of the dashed lined boxes illustrates an alternative processor 900 with multiple cores 902(A)-(N), a set of one or more integrated memory controller unit(s) circuitry 914 in the system agent unit circuitry 910, and special purpose logic 908, as well as a set of one or more interconnect controller units circuitry 916. Note that the processor 900 may be one of the processors 870 or 880, or co-processor 838 or 815 of FIG. 8.

Thus, different implementations of the processor 900 may include: 1) a CPU with the special purpose logic 908 being integrated graphics and/or scientific (throughput) logic (which may include one or more cores, not shown), and the cores 902(A)-(N) being one or more general purpose cores (e.g., general purpose in-order cores, general purpose out-of-order cores, or a combination of the two); 2) a coprocessor with the cores 902(A)-(N) being a large number of special purpose cores intended primarily for graphics and/or scientific (throughput); and 3) a coprocessor with the cores 902(A)-(N) being a large number of general purpose in-order cores. Thus, the processor 900 may be a general-purpose processor, coprocessor or special-purpose processor, such as, for example, a network or communication processor, compression engine, graphics processor, GPGPU (general purpose graphics processing unit circuitry), a high-throughput many integrated core (MIC) coprocessor (including 30 or more cores), embedded processor, or the like. The processor may be implemented on one or more chips. The processor 900 may be a part of and/or may be implemented on one or more substrates using any of a number of process technologies, such as, for example, bipolar complementary metal oxide semiconductor (CMOS) (BiCMOS), CMOS, or N-type metal oxide semiconductor (NMOS).

A memory hierarchy includes one or more levels of cache unit(s) circuitry 904(A)-(N) within the cores 902(A)-(N), a set of one or more shared cache unit(s) circuitry 906, and external memory (not shown) coupled to the set of integrated memory controller unit(s) circuitry 914. The set of one or more shared cache unit(s) circuitry 906 may include one or more mid-level caches, such as level 2 (L2), level 3 (L3), level 4 (L4), or other levels of cache, such as a last level cache (LLC), and/or combinations thereof. While in some examples ring-based interconnect network circuitry 912 interconnects the special purpose logic 908 (e.g., integrated graphics logic), the set of shared cache unit(s) circuitry 906, and the system agent unit circuitry 910, alternative examples use any number of well-known techniques for interconnecting such units. In some examples, coherency is maintained between one or more of the shared cache unit(s) circuitry 906 and cores 902(A)-(N).

In some examples, one or more of the cores 902(A)-(N) are capable of multi-threading. The system agent unit circuitry 910 includes those components coordinating and operating cores 902(A)-(N). The system agent unit circuitry 910 may include, for example, power control unit (PCU) circuitry and/or display unit circuitry (not shown). The PCU may be or may include logic and components needed for regulating the power state of the cores 902(A)-(N) and/or the special purpose logic 908 (e.g., integrated graphics logic). The display unit circuitry is for driving one or more externally connected displays.

The cores 902(A)-(N) may be homogenous or heterogeneous in terms of architecture instruction set architecture (ISA); that is, two or more of the cores 902(A)-(N) may be capable of executing the same ISA, while other cores may be capable of executing only a subset of that ISA or a ISA.

References to “one example,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

Illustrative examples include, but are not limited to:

1. An apparatus comprising:
a physical stimulus device to generate a physical output;
memory to store animal tracking and movement software;
a processor to execute the animal tracking and movement software to:
   when coupled to an animal trained to according to input from the physical stimulus, direct movement of the animal coupled to the apparatus along a multi-turn route using physical output of the physical stimulus device based at least in part on a location of the animal with respect to a destination grazing area.
      2. The apparatus of example 1, wherein the physical stimulus device is one or more of an audio device, smell generating device, an electrical device, and a vibrating motor.
      3. The apparatus of any of examples 1-2, further comprising:
one or more communication devices including one or more of a satellite communications device, a wired communications device, and a wireless communications device.
   4. The apparatus of any of examples 1-3, wherein the animal tracking and movement software, when executed, is further to determine the route based on one or more of environmental information of the destination grazing area, a health status of the animal coupled to the apparatus, and environmental information of a present location of the animal coupled to the apparatus.
   5. The apparatus of any of examples 1-4, wherein the route comprises a plurality of way points.
   6. The apparatus of example 5, wherein each of the plurality of way points is associated with a different physical output.
   7. The apparatus of example 6, wherein the different physical outputs comprise different amplitudes and frequencies of a vibration.
   8. The apparatus of example 6, wherein the different physical outputs comprise different smells.
   9. The apparatus of example 6, wherein the different physical outputs comprise different electrical characteristics.
   10. The apparatus of any of examples 1-9, wherein the animal tracking and movement software, when executed, is further to determine a health status of the animal coupled to the apparatus from one or more sensors of the apparatus.
   11. A system comprising:
an animal behavior device comprising:
   a physical stimulus device to generate a physical output,
   memory to store animal tracking and movement software, and
   a processor to execute the animal tracking and movement software to:
      when coupled to an animal trained to according to input from the physical stimulus, direct movement of the animal coupled to the apparatus along a multi-turn route using physical output of the physical stimulus device based at least in part on a location of the animal with respect to a destination grazing area;
one or more devices to implement an animal tracking and movement service in a multi-tenant provider network, the animal tracking and movement service including instructions that upon execution cause the animal tracking and movement service to generate the route; and
a communication device to communicate with the animal behavior device to provide the generated route from the animal tracking and movement service.
   12. The system of example 11, wherein the physical stimulus device is one or more of an audio device, smell generating device, an electrical device, and a vibrating motor.
   13. The system of any of examples 11-12, wherein the animal behavior device further comprises”
one or more communication devices including one or more of a satellite communications device, a wired communications device, and a wireless communications device.
   14. The system of any of examples 11-13, wherein the animal tracking and movement service is further to determine the route based on one or more of environmental information of the destination grazing area, a health status of the animal coupled to the apparatus, and environmental information of a present location of the animal coupled to the apparatus.
   15. The system of any of examples 11-14, wherein the route comprises a plurality of way points.
   16. The system of example 11, wherein each of the plurality of way points is associated with a different physical output.
   17. The system of example 16, wherein the different physical outputs comprise different amplitudes and frequencies of a vibration.
   18. The system of example 16, wherein the different physical outputs comprise different smells.
   19. The system of example 16, wherein the different physical outputs comprise different electrical characteristics.
   20. The apparatus of any of examples 11-19, wherein the animal tracking and movement software, when executed, is further to determine a health status of the animal coupled to the apparatus from one or more sensors of the apparatus.

Moreover, in the various examples described above, unless specifically noted otherwise, disjunctive language such as the phrase “at least one of A, B, or C” is intended to be understood to mean either A, B, or C, or any combination thereof (e.g., A, B, and/or C). As such, disjunctive language is not intended to, nor should it be understood to, imply that a given example requires at least one of A, at least one of B, or at least one of C to each be present.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

What is claimed is:

1. An apparatus comprising:
a physical stimulus device to generate a physical output;
memory to store animal tracking and movement software;
a processor to execute the animal tracking and movement software to:
when coupled to an animal trained to according to input from the physical stimulus, direct movement of the animal coupled to the apparatus along a multi-turn route using physical output of the physical stimulus device based at least in part on a location of the animal with respect to a destination grazing area.

2. The apparatus of claim 1, wherein the physical stimulus device is one or more of an audio device, smell generating device, an electrical device, and a vibrating motor.

3. The apparatus of claim 1, further comprising:
one or more communication devices including one or more of a satellite communications device, a wired communications device, and a wireless communications device.

4. The apparatus of claim 1, wherein the animal tracking and movement software, when executed, is further to determine the route based on one or more of environmental information of the destination grazing area, a health status of the animal coupled to the apparatus, and environmental information of a present location of the animal coupled to the apparatus.

5. The apparatus of claim 1, wherein the route comprises a plurality of way points.

6. The apparatus of claim 1, wherein each of the plurality of way points is associated with a different physical output.

7. The apparatus of claim 6, wherein the different physical outputs comprise different amplitudes and frequencies of a vibration.

8. The apparatus of claim 6, wherein the different physical outputs comprise different smells.

9. The apparatus of claim 6, wherein the different physical outputs comprise different electrical characteristics.

10. The apparatus of claim 1, wherein the animal tracking and movement software, when executed, is further to determine a health status of the animal coupled to the apparatus from one or more sensors of the apparatus.

11. A system comprising:
an animal behavior device comprising:
a physical stimulus device to generate a physical output,
memory to store animal tracking and movement software, and
a processor to execute the animal tracking and movement software to:
when coupled to an animal trained to according to input from the physical stimulus, direct movement of the animal coupled to the apparatus along a multi-turn route using physical output of the physical stimulus device based at least in part on a location of the animal with respect to a destination grazing area;
one or more devices to implement an animal tracking and movement service in a multi-tenant provider network, the animal tracking and movement service including instructions that upon execution cause the animal tracking and movement service to generate the route; and
a communication device to communicate with the animal behavior device to provide the generated route from the animal tracking and movement service.

12. The system of claim 11, wherein the physical stimulus device is one or more of an audio device, smell generating device, an electrical device, and a vibrating motor.

13. The system of claim 11, wherein the animal behavior device further comprises:
one or more communication devices including one or more of a satellite communications device, a wired communications device, and a wireless communications device.

14. The system of claim 11, wherein the animal tracking and movement service is further to determine the route based on one or more of environmental information of the destination grazing area, a health status of the animal coupled to the apparatus, and environmental information of a present location of the animal coupled to the apparatus.

15. The system of claim 11, wherein the route comprises a plurality of way points.

16. The system of claim 11, wherein each of the plurality of way points is associated with a different physical output.

17. The system of claim 16, wherein the different physical outputs comprise different amplitudes and frequencies of a vibration.

18. The system of claim 16, wherein the different physical outputs comprise different smells.

19. The system of claim 16, wherein the different physical outputs comprise different electrical characteristics.

20. The apparatus of claim 11, wherein the animal tracking and movement software, when executed, is further to determine a health status of the animal coupled to the apparatus from one or more sensors of the apparatus.
